(19) United States
(12) Patent Application Publication
(10) Pub. No.: US 2010/0030851 A1
(43) Pub. Date: Feb. 4, 2010

(54) LOAD BALANCER, LOAD-BALANCING METHOD, AND RECORDING MEDIUM WITH LOAD-BALANCING PROGRAM

(75) Inventors: Takashi Inden, Kawasaki (JP); Kazuhiro Watanabe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/512,848

(22) Filed: Jul. 30, 2009

(30) Foreign Application Priority Data
Aug. 4, 2008 (JP) 2008-200432

(51) Int. Cl. G06F 15/16

(52) U.S. Cl. 709/203; 709/226; 709/228

(57) ABSTRACT

A load balancer includes: a license control unit that performs a process for collecting license information managed by plurality of servers; a connection management unit that manages a connection between the server to be allocated which is specified by the reply and the client, and notifying, when the connection is established, the license control unit of the identification information on the server to be allocated and the identification information on the license used for the connection; and an allocation processing unit that selects the servers that are the allocation candidates on the license of the determination request, and inquiring of the license control unit about the use state of the license by the selected server, and a process for specifying the server to be allocated from the allocation candidate servers, and notifying the connection management unit of the license included in the reply to the inquiry.

### CROSS-REFERENCE TO RELATED APPLICATIONS

This application is based upon and claims the benefit of priority of the prior Japanese Patent Application No. 2008-200432, filed on Aug. 4, 2008, the entire contents of which are incorporated herein by reference.

### FIELD

The present invention relates to server load distribution techniques using license information on a server.

### BACKGROUND

Acceptance of the Internet had led to an increase in the number of internet users together with increased requests for Internet sites. An increase in the requests causes concern about the deterioration of service such that a response from websites is late, or connection to the website is difficult.

For that reason, there has been proposed a technique by which servers are readily scalable when the capability of the websites runs short, a technique by which the service is not allowed to suspend when a failure occurs, and a technique by which the service is maintained or repaired without being interrupted (refer to Japanese Laid-open Patent Publication No. 2000-268012).

The load balancer has a representative address (virtual IP address) as a virtual server, and distributes access to the virtual IP address to any one of a plurality of servers to be allocated on the basis of a given distribution policy, and performs the control of sessions and the maintenance of continuous service.

As the distribution policy of access, there have been known several static and dynamic distribution systems such as selection based on a given order (round-robin) or selection based on the smallest number of clients, the lowest CPU load factor, etc.

Incidentally, access control may be conducted on the distributed service by the load balancer according to the number of licenses on the allocated server. For example, access control is performed when the number of clients connectable to a port, etc. used by an application is identified by an IP address, etc., and an upper limit of the number of connectable clients is set to perform access control.

In this case, when the quantity of licenses available for the service allocated to the server has reached the upper limit, allocation may be invalidated (NG).

In order to prevent the above condition, in the related art load balancer, the number of connections of a subject service, or the like is regarded as the quantity of licenses, and the quantity of accesses (the number of connections) to each server is controlled by the same value as the upper limit of the quantity of licenses.

However, the upper limit of the quantity of licenses needs to be consciously set by a user for each server, resulting in a problem in that the setting operation is troublesome.

Even if the setting operation is conducted, the number of connections is not always equal to the quantity of licenses. This leads to a problem because the access load is not efficiently distributed.

### BRIEF DESCRIPTION OF DRAWINGS

FIG. 1 depicts a configuration example of this embodiment.

FIG. 2 depicts processing of a license management agent of a server.

FIG. 3 depicts a data formation example of license information.

FIG. 4 depicts respective processing units in a load balancer.

FIG. 5 depicts a data formation example of license management information.

FIG. 6 depicts a data formation example of license connection information.

FIG. 7 depicts a data formation example of allocation information.

FIG. 8 depicts a processing flow for collecting the license information.

FIG. 9 depicts a processing flow for monitoring a state of license.

FIG. 10 depicts a processing flow for specifying an allocation target at the time of establishing connection, and reflecting the specified result in the license management information.

FIG. 11 depicts a processing flow for reflecting a connection release in the license management information.

FIG. 12 depicts a processing flow for reflecting a change in license information in the license management information.

FIGS. 13A and 13B depict a data formation example of a license information request P1 and a license information reply P2, respectively.

FIGS. 14A and 14B depict a data formation example of a license information request P3 and a license information reply P4, respectively.

FIGS. 15A and 15B depict a data formation example of a license state monitoring confirmation P5 and a license state monitoring reply P6, respectively.

FIG. 16 depicts a data formation example of a license state change notification P7.

### SUMMARY

According to an aspect of the embodiment, a load balancer which is connected to a plurality of clients each having a license for server access and a plurality of servers each offering a service to the clients based on license information managed by the apparatus, and distributes the access from the clients to the servers. The apparatus includes:

a license control unit that performs a process for collecting the license information managed by the plurality of servers, respectively, and managing the use state of the license of each of the plurality of servers based on license management information that records the usable quantity, the used quantity, and availability/unavailability of the license in each of the servers and each of licenses, a process for answering availability or unavailability of an appropriate license from the license management information in response to an inquiry of the use state of the license in allocation candidate servers to which an access from the client are allocatable (i.e., available), and a process for updating the used quantity and the use state of the license management information on the license used by the server connected when the connection of the client is established;

a connection management unit that performs a process for extracting, when receiving an access request to the server from the client, identification information on the license possessed by the requesting client from a packet of the access request, and issuing an allocation target determination request based on the identification information on the extracted license, and a process for accepting a reply to the determination request, managing a connection between the server to be allocated which is specified by the reply and the client, and notifying, when the connection is established, the license control unit of the identification information on the server to be allocated and the identification information on the license used for the connection; and

an allocation processing unit that performs a process for holding allocation information defining a correspondence relationship between each of the plurality of servers and the allocatable licenses in advance, selecting the servers being the allocation candidates from the allocation information based on the identification information of the license of the determination request when accepting the determination request, and inquiring of the license control unit about the use state of the license by the selected server, and a process for specifying the server to be allocated from the allocation candidate servers, and notifying the connection management unit of the specified server based on the availability or unavailability of the license included in the reply to the inquiry.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### DESCRIPTION OF EMBODIMENTS

In this embodiment, a load balancer and servers are interlocked with each other through communication. The load balancer collects license information held at a server side, manages a license use state of each server based on the collected license information in a pseudo fashion, and determines the server to be allocated based on the license use state of each server, thereby realizing effective load distribution.

The server to be allocated detects a change in the license state and notifies the load balancer of the detected change whereby the load balancer realizes appropriate and flexible load distribution.

The load balancer includes a license control unit, a connection management unit, and an allocation control unit.

The license control unit executes a process of collecting the license information managed by a plurality of servers, respectively, and managing the use state of each license of the plurality of servers based on the license management information where the usable quantity, the used quantity, and the availability/unavailability of licenses are recorded for each server and each license, a process of answering the availability or unavailability of an appropriate license from the license management information to an inquiry about the use state of licenses in allocation candidate servers to which an access from a client is to be allocated, and a process of updating the used quantity and the use state of the license management information for the licenses used in the connected server at the time of establishing connection of the client.

When receiving an access request to the server from the client, the connection management unit executes a process of extracting identification information of the license possessed by the requesting client from a packet of the access request, and issuing a determination request of the allocation target based on the identification information of the extracted license, and a process of accepting a reply to the determination request, managing a connection between the server to be allocated which has been specified by the reply and the client, and notifying the license control unit of the identification information on the server to be allocated and the identification information on the license used for the connection when the connection is established.

The allocation processing unit executes a process of holding allocation information that defines a correspondence relationship between each of the plurality of servers and the allocatable licenses in advance, and selecting, when accepting the determination request, servers being allocation candidates from the allocation information based on the identification information on the license of the allocation request, and inquiring of the license control unit about the use state of the license by the selected server, and a process of specifying the server to be allocated from the servers being the allocation candidates based on the availability or unavailability of the license included in the reply to the inquiry, and notifying the connection management unit of the specified server.

In the load balancer, the license control unit collects the license information managed by the plurality of servers, respectively, holds the license management information where the usable quantity, the used quantity, and the availability/unavailability of licenses are recorded for each server and each license in a memory unit in advance, and manages the use state of the licenses in each server based on the license management information.

When receiving the access request to the server from the client, the connection management unit extracts the identification information of the license possessed by the requesting client from the packet of the access request, and issues the determination request of the allocation target to the allocation processing unit based on the extracted identification information of the license.

The allocation processing unit holds the allocation information that defines the correspondence relationship between each of the plurality of servers and the allocatable licenses in advance, and selects, when accepting the determination request, the servers that are allocation candidates from the allocation information based on the identification information on the license of the determination request, and inquires of the license control unit about the use state of the license at the selected servers.

The license control unit answers the availability or unavailability of an appropriate license from the license management information to the inquiry about the use state of the license of the selected licenses.

The allocation processing unit specifies the server to be allocated from the servers that are allocation candidates based on the availability or unavailability of the licenses included in the reply to the inquiry.

The connection management unit manages the connection between the server to be allocated and the client, and notifies the license control unit of the identification information on the server to be allocated and the identification information on the license used for the connection when establishing the connection.

The license control unit updates the used quantity and use state of the license management information on the license used in the connected server when the connection is established.

As a result, the load balancer generates the license management information from the license information collected from the server, updates the use state (availability or unavailability) of the appropriate license in the license management information according to the establishment/release of the connection, and can set the license usable server as a server to be allocated based on the license corresponding to each server and the use state of that license when allocating the access request from the client to the servers.

As described above, according to this embodiment, the license information on each server and its use state (availability/unavailability) are managed in a pseudo fashion, and an access from the client can be allocated to the server that does not exceed the upper limit of the usable license quantity. This makes it possible to reduce allocation that allows access refused by the server which is attributable to an excess of the license quantity over the upper limit.

The load balancer can automatically acquire the license information on the server. For that reason, there is required no user work for consciously setting the definition information on the license information to the load balancer, etc.

Because the use state of the license of the server can be managed to determine the access server to be allocated within the load balancer being a relay point, a processing time from the access from the client to determination of the server to be allocated can be reduced more than that in the related art.

The state of the service requiring the license for the server can be steadily monitored. Hence, the load balancer can timely and flexibly follow the occurrence of a down (nonexecutable) state of the service associated with the license, a change in the quantity of licenses, etc.

Since the load balancer can receive a notification of a change in the state of the license from the server side, the apparatus can flexibly follow the change state, likewise.

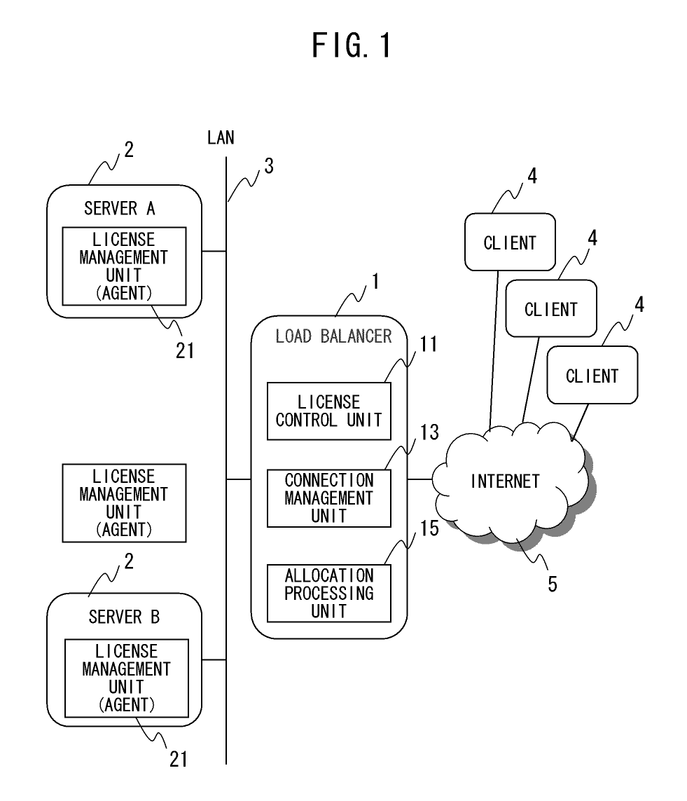

FIG. 1 depicts a configuration example in an embodiment of the present invention.

A load balancer 1 is connected to a plurality of servers 2 to be allocated through a LAN 3, respectively, and also connected to clients 4 each having a license that can enjoy a service of each server 2 through an internet 5.

The load balancer 1 manages license information on the servers 2, distributes an access request from each client 4 to one server 2 based on the use state of the license in each server 2, and controls the connection between the client 4 and the server 2. The access from the client 4 means a connection establishment/release request and a receive packet of data or the like.

The load balancer 1 has a license control unit 11, a connection management unit 13, and an allocation processing unit 15.

The license control unit 11 collects the license information on each server 2, and manages the use state of each license.

The connection management unit 13 manages the connection establishment from each client 4, and notifies the license control unit 11 of establishment/release of the connection to the server 2 to be allocated, addition/deletion of the client (client IP), etc.

The allocation processing unit 15 determines the server to be allocated based on the allocation information and the license information. The allocation information is information for defining a correlation relationship between the respective servers 2 and the allocatable licenses.

The servers 2 are each equipped with a license management unit (license management agent) 21.

The license management agent 21 updates the license information managed by the subject server 2 in response to a license information request from the load balancer 1.

Hereinafter, processing of the load balancer 1 and the servers 2 will be described below.

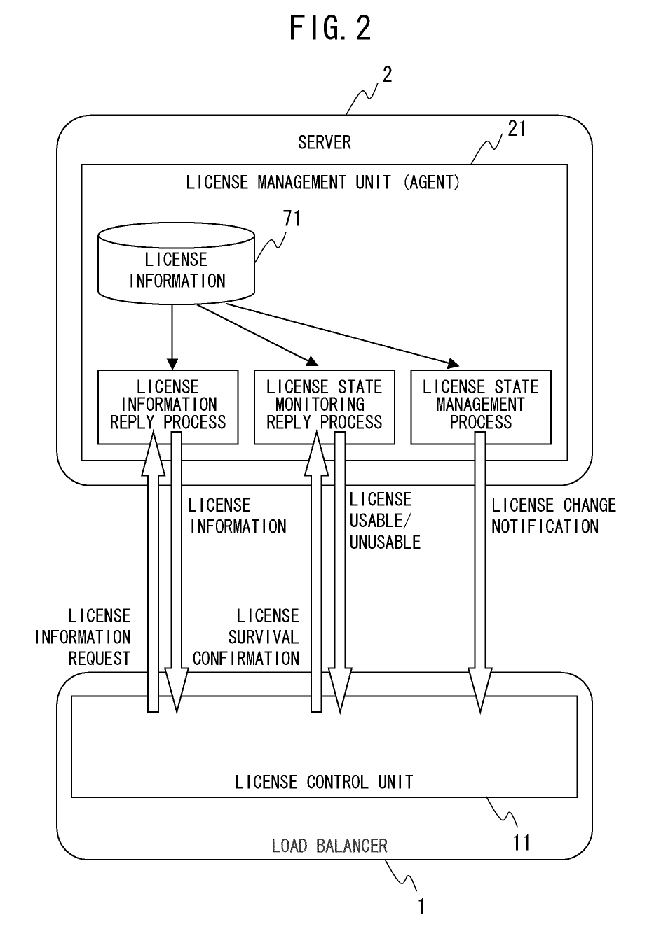

FIG. 2 depicts processing of the license management agent 21 in each server 2.

The license management agent 21 of the server 2 holds license information 71 related to licenses managed by the subject apparatus, and manages the licenses.

The license information 71 is user-defined information on the license management agent 2.

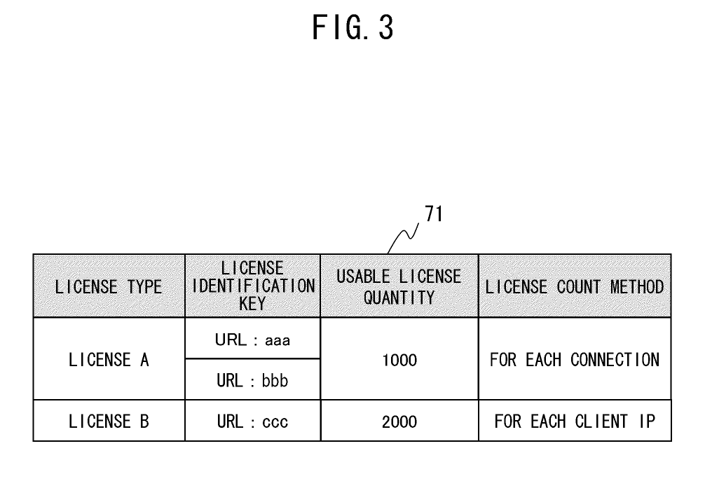

FIG. 3 depicts a data formation example of the license information 71.

The license information 71 includes the respective data items of “license type (license A, license B, etc.)” indicative of the types of licenses, “license identification key (URL: aaa, URL: bbb, URL: ccc, etc.)” setting keys each for identifying a license to be used, “the usable license quantity” setting an upper limit of the usable license quantity, and “license count method (for each connection, for each client IP, etc.) setting a resource being a count target (resource to be counted) when the use quantity of licenses is counted.

The “for each connection” in the “license count method” represents the license count in units of the connection, that is, the number of connections using the license is the use quantity of the license. Likewise, the “for each client IP” indicates that counting is made in units of the client IP.

Upon accepting the license information request from the license control unit 11 in the load balancer 1, the license management agent 21 transmits the license information 71 to the license control unit 11 as a license information reply process.

Upon accepting a license survival confirmation from the license control unit 11, the license management agent 21 answers, as a license state monitoring reply process, the status of license, for example, the availability of the service, a change in the usable quantity of licenses, etc.

The license management agent 21 issues a license change notification to the license control unit 11 as a license state monitoring reply process when there is a change in the upper limit of the quantity of licenses managed by the subject server, the license count method, or the like.

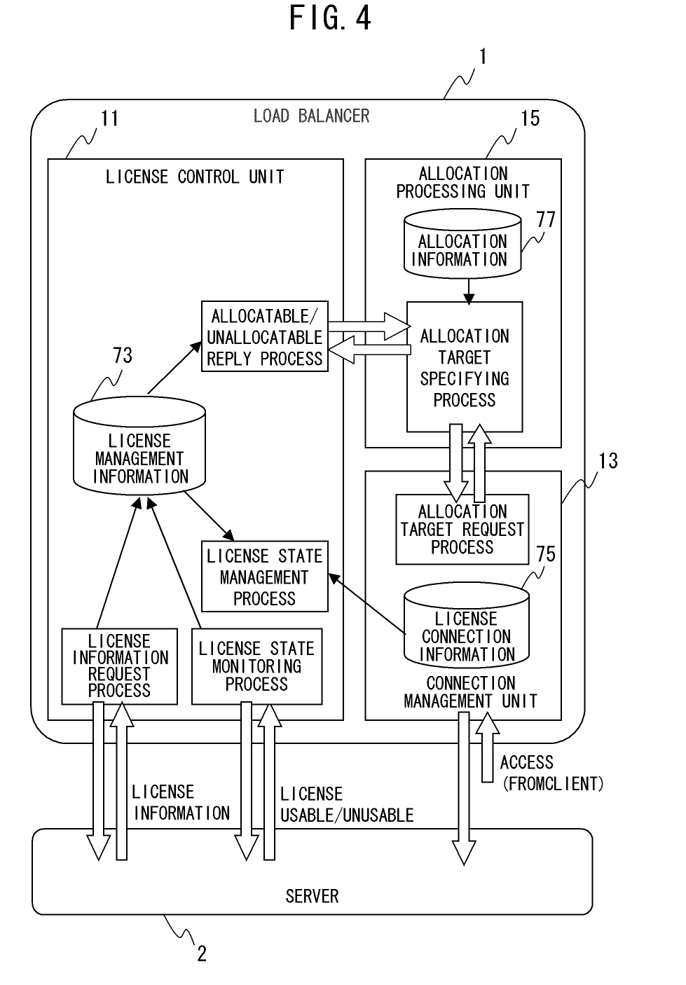

FIG. 4 depicts processing of the respective processing units in the load balancer 1.

When the load balancer 1 starts or accepts the license change notification from the server 2, the license control unit 11 transmits, as a license information request process, a license information request to the license management agent 21 of each server 2, and collects the license information 71. Then, the license management agent 21 generates the license management information 73 from the collected license information 71, and holds the license management information 73 in a license management information memory unit (not depicted).

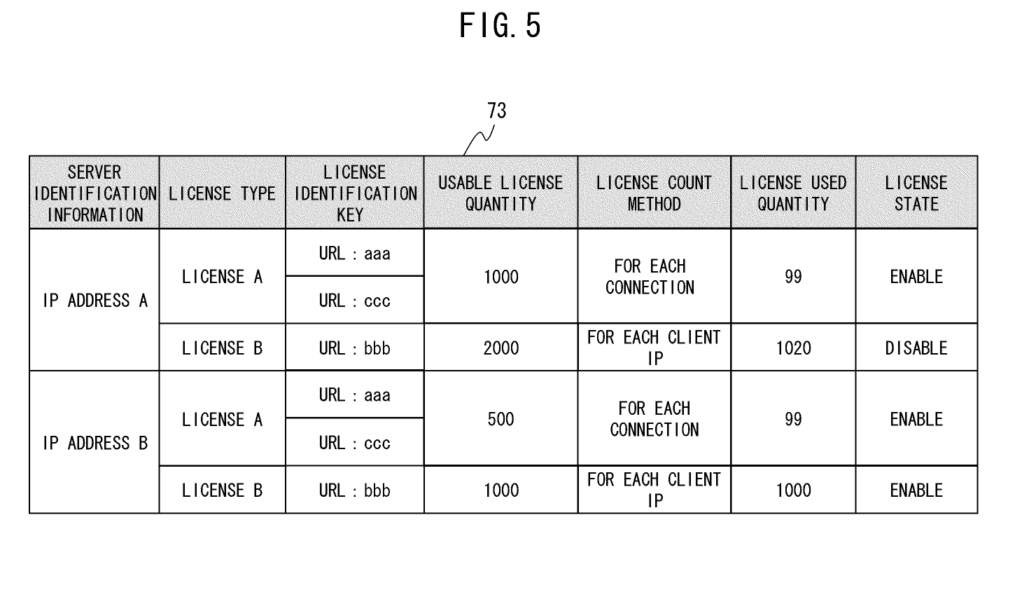

FIG. 5 depicts a data formation example of the license management information 73.

The license management information 73 includes respective data items of “server identification information (IP address A, IP address B, etc.)” for setting identification information (IP address) on the servers, “license type (license A, license B, etc.)”, “license identification key (URL: aaa, URL: bbb, URL: ccc, etc.)”, “usable license quantity”, “license count method” for setting the resource to be counted when the used quantity of license is counted, “license used quantity” indicative of the used quantity due to the resource to be counted of each license being in use, and “license state” indicating whether the license is usable or unusable.

The “enable” of “license state” is indicative of a state where the licenses used quantity is equal to or lower than a given rate/quantity with respect to the usable license quantity, and the license is usable. The “disable” is indicative of a state where the license used quantity exceeds the given rate/quantity with respect to the usable license quantity, and the use of license is disabled at an appropriate time point.

The license control unit 11 transmits, as the license state monitoring process, a license survival confirmation to the license management agent 21 in a given period or opportunity, and receives, from the license management agent 21, a status of the license, for example, information on the lowered service, a change in the usable license quantity, etc.

Upon accepting the license change notification from the license management agent 21 of the server 2 whose license information 71 is changed or the server 2 having the license information 71 newly added, the license control unit 11 transmits the license information request to the notifying server 2 to again conduct an inquiry.

With the above operation, because the license information on the server 2 is automatically acquired, there is no need for the user to consciously set the definition information or the like on the license information in the load balancer 1. Similarly, when the service related to the license is lowered or the quantity of license is changed in the server 2, the change state can be immediately reflected in the license management information 73.

The license control unit 11 accepts inquiry information from the allocation processing unit 15 as an allocatable/unallocatable reply process.

The inquiry information is produced based on allocation information 77 which will be described later, where identifiers of the servers 2 (IP addresses of the servers 2) which are selected as allocation candidates, and allocation keys thereof (service types or license identification keys) are set.

The license control unit 11 determines the license of the appropriate server 2 from the license management information 73 based on the inquiry information, confirms the used quantity of license and the license use state (usable or unusable), and answers the availability/unavailability of the appropriate license of the server 2. When the license state of the license management information 73 is “enable”, the license control unit 11 answers “usable (allocatable)”, and when the license state is “disable”, the license control unit 11 answers “unusable (unallocatable)”.

Further, upon accepting a connection establishment notification based on a license connection information 75 which will be described later from the connection management unit 13, the license control unit 11 determines, as a license state management process, the license of the appropriate server 2 from the license management information 73, and adds the license used quantity based on the connection establishment notification by the resource to be counted.

Also, upon accepting the connection release notification, the license control unit 11 subtracts the license used quantity, likewise. When the used quantity is changed by the connection establishment/release notification, the license control unit 11 determines the use state (enable/disable) of the license based on the usable license quantity and the used quantity, and changes the use state.

The connection management unit 13 allocates the communication of the client 4 to the servers 2, and manages the communication for each connection.

When the received packet from the client 4 is a new connection establishment request, the connection management unit 13 extracts, as an allocation target request process, the license identification key from the received packet of the client 4, and notifies the determination request of the allocation target with the license identification key to the allocation processing unit 15.

Upon accepting reply information indicative of the server 2 to be allocated from the allocation processing unit 15, the connection management unit 13 manages the connection between the requesting client 4 and the server 2 to be allocated, generates the license connection information 75 of the connection, and notifies the license control unit 11 of a connection establishment notification including the license connection information 75.

When there is a connection release between the requesting client 4 and the server 2 to be allocated, or the like, the connection management unit 13 notifies the license control unit 11 of the connection release notification including the appropriate license connection information 75.

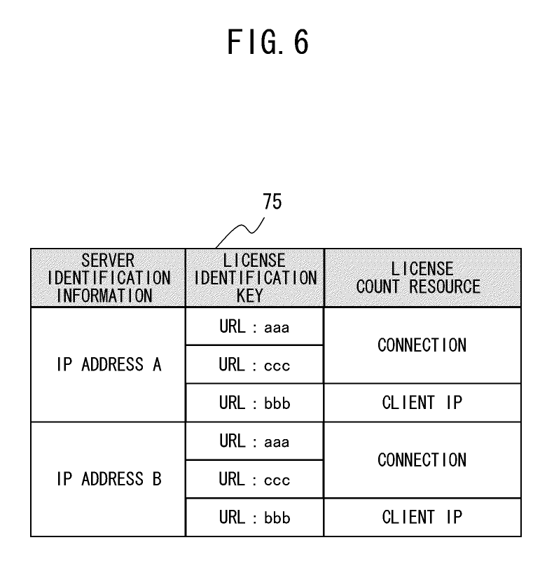

FIG. 6 depicts the data formation example of the license connection information 75.

The license connection information 75 includes the respective data items of “server identification information”, “license identification key”, and “license count resource (connection/client IP, etc.)”.

The allocation processing unit 15 holds the allocation information 77, and as an allocation target specifying process, accepts the allocation target determination request from the connection management unit 13, and selects allocation candidate servers that match the license identification key of the allocation target determination request based on the allocation information 77.

The allocation processing unit 15 inquires of the license control unit 11 about whether the servers 2 selected as the allocation candidate servers are allocatable.

The allocation processing unit 15 determines, from the license control unit 11, the server 2 to be allocated based on the reply information indicative of whether the servers 2 selected as the allocatable allocation candidate servers, and notifies the connection management unit 13 of the determined result.

The allocation information 77 sets a correspondence relationship between the servers 2 to be allocated and the allocatable licenses, and is referred to as “original information” in a process of producing the license management information 73.

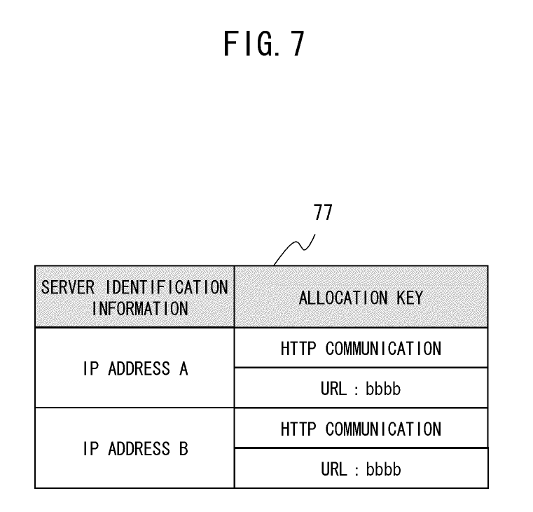

FIG. 7 depicts the data formation example of the allocation information 77.

The allocation information 77 includes the respective data items of “server identification information” for identifying the servers 2 to be allocated, and “allocation key (service types, license identification keys, etc.)” for setting the license identification keys to be allocated to the servers 2.

In this way, there is no need to inquire of the server 2 about the license information and the use state thereof, and the server 2 to be allocated can be determined by using the license management information 73 held within the load balancer 1. Therefore, a processing time for allocating the access from the client 4 can be made shorter than that in the conventional art.

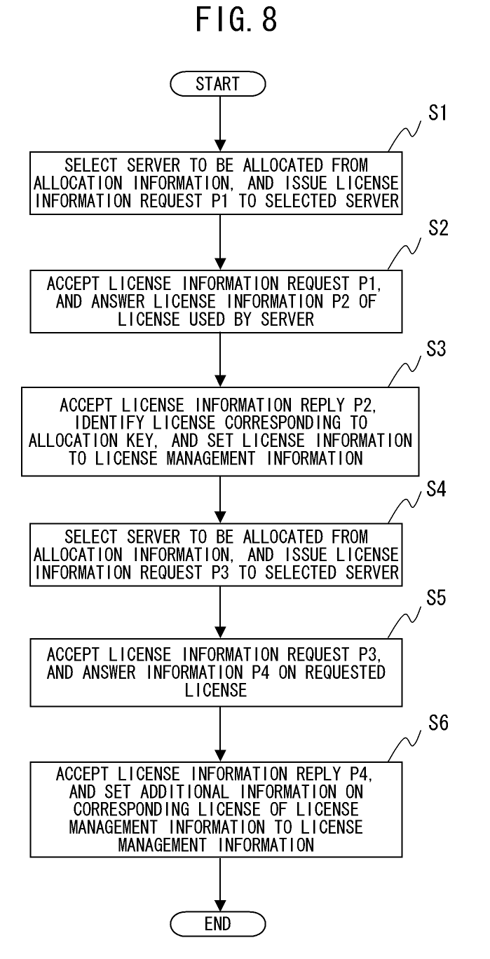

FIGS. 8 to 12 depict processing flows of the respective processing by the load balancer 1.

FIG. 8 is a processing flow for collecting the license information.

In the processing flow depicted in FIG. 8, the license control unit 11 selects the server 2 to be allocated with reference to the allocation information 77, and issues a license information request P1 to the license management agent 21 of the selected server 2 (Step S1).

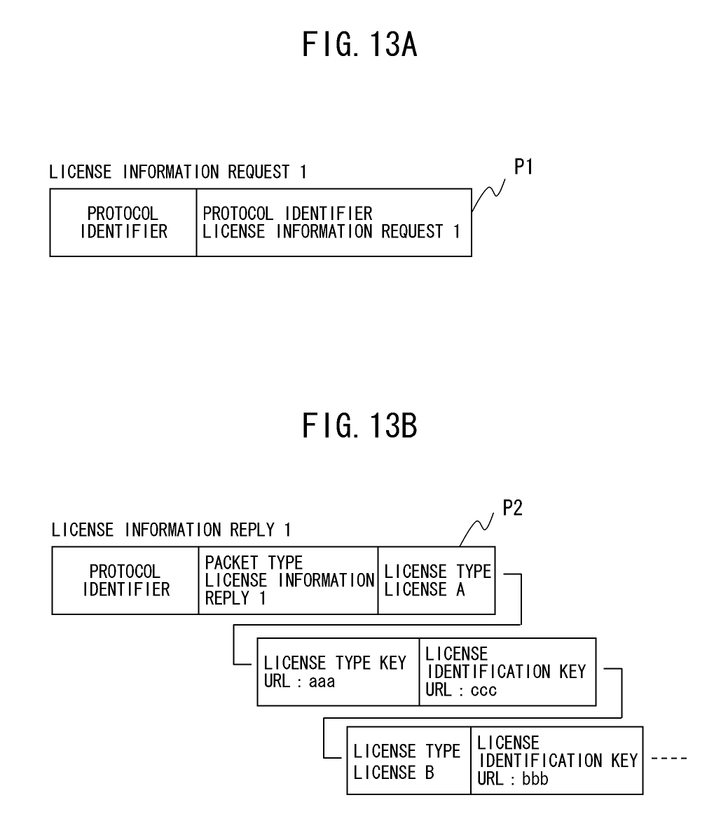

The license information request P1 includes a protocol identifier and a packet type (license information request 1) as depicted in FIG. 13A.

Upon accepting the license information request P1, the license management agent 21 of the server 2 answers a license information reply P2 with the license information on all licenses which are managed by the subject server as contents (Step S2).

The license information reply P2 includes the protocol identifier, the packet type (license information reply 1), the license type (license A, etc.), and the license identification key (URL: aaa, etc.) as depicted in FIG. 13B.

Upon accepting the license information reply P2, the license control unit 11 identifies the license corresponding to the allocation key of the allocation information 77 (for example, license whose allocation key is “HTTP communication”, and whose license identification key is “URL: aaa”), and sets that information to the license management information 73 (Step S3).

The license control unit 11 issues the license information request P3 to the license management agent 21 (Step S4).

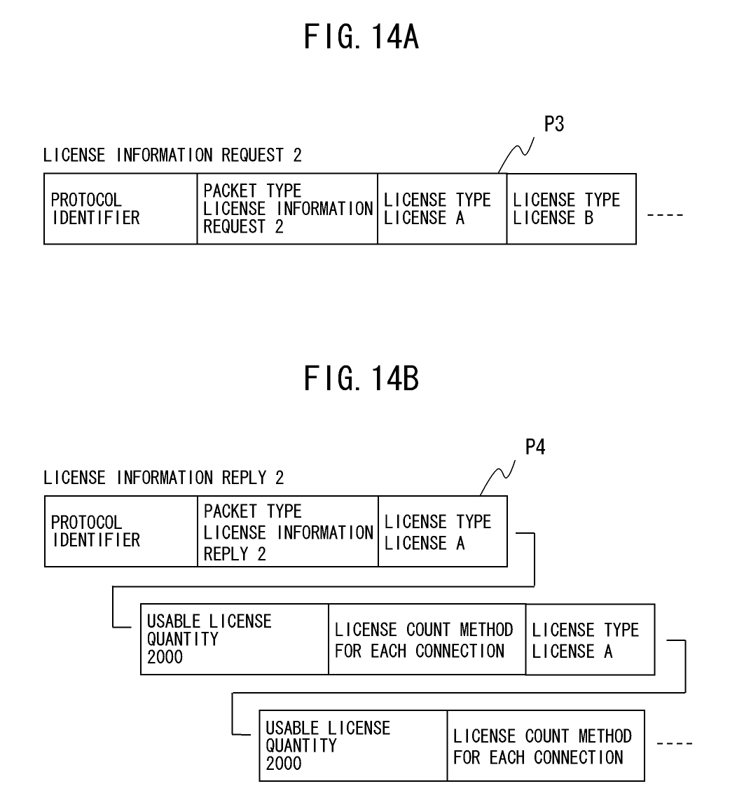

The license information request P3 includes the protocol identifier, the packet type (license information request 2), and the license type (license A, etc.) as depicted in FIG. 14A.

Upon accepting the license information request P3, the license management agent 21 answers a license information reply P4 to the requested license (Step S5).

The license information reply P4 includes the protocol identifier, the packet type (license information reply 2), the license type (license A, etc.), the usable license quantity, and the license count method (for each connection, etc.) as depicted in FIG. 14B.

Upon accepting the license information reply P4, the license control unit 11 sets additional information on the license information reply P4 to the item of the corresponding license of the license management information 73 (Step S6).

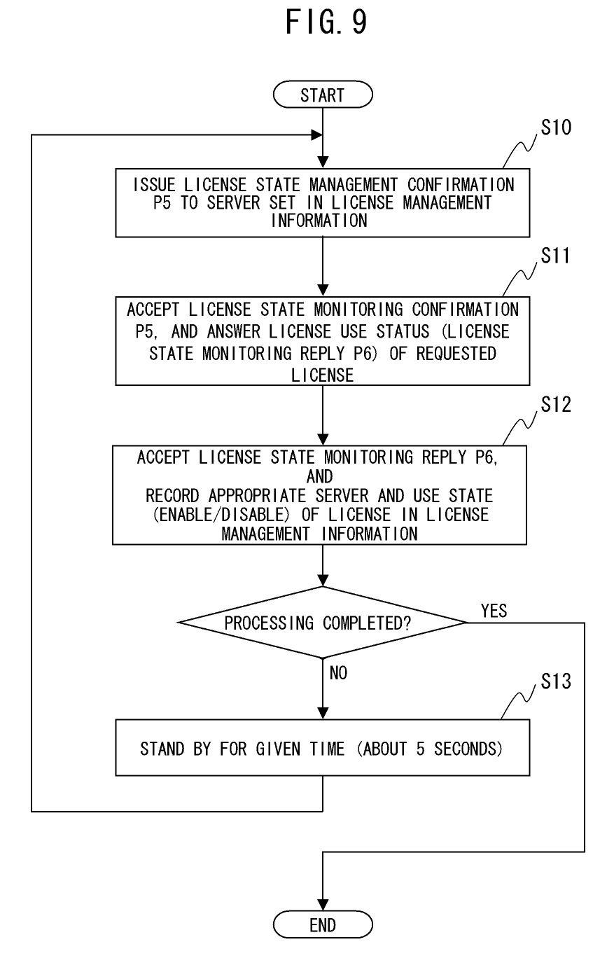

FIG. 9 is a processing flow for monitoring the state of license.

In the processing flow depicted in FIG. 9, the license control unit 11 issues a license state monitoring confirmation P5 to the server 2 set in the license management information 73, and monitors the state of licenses (Step S10).

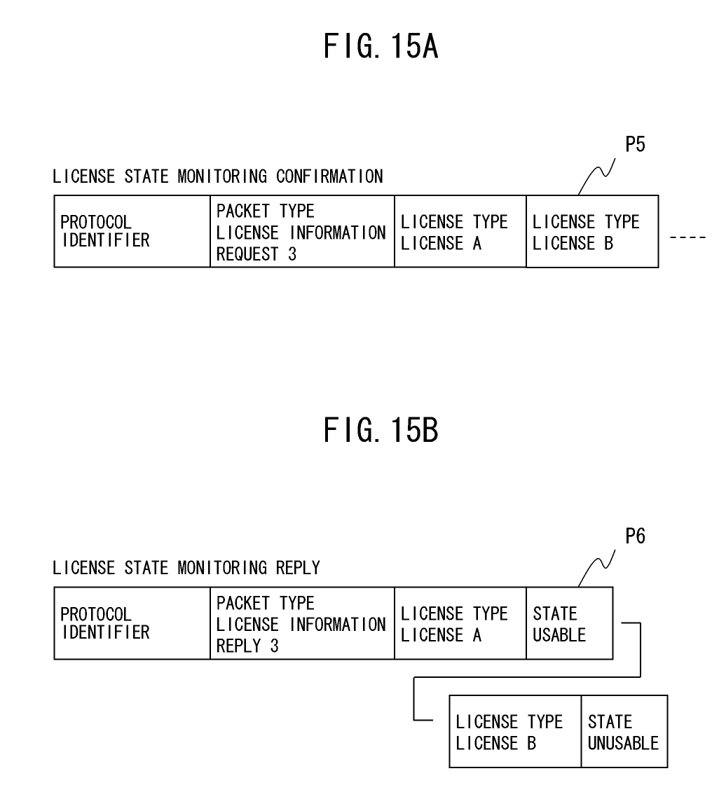

The license state monitoring confirmation P5 includes the protocol identifier, the packet type (license information request 3), and the license type (license A, etc.) as depicted in FIG. 15A.

Upon accepting the license state monitoring confirmation P5, the license management agent 21 answers a license state monitoring reply P6 with the use state of the requested license as contents (Step S11).

The license state monitoring reply P6 includes the protocol identifier, the packet type (license information reply 3), the license type (license A, etc.), and a state (usable/unusable) as depicted in FIG. 15B.

Upon accepting the license state monitoring reply P6, the license control unit 11 records “enable/disable” in the appropriate server of the license management information 73 and the license state (use state) of the license (Step S12).

The license control unit 11 stands by for a given period of time (for example, about 5 seconds) (Step S13), thereafter returns to processing in Step S10, and repeats processing of S10 to S13 until the processing of the load balancer 1 has been completed.

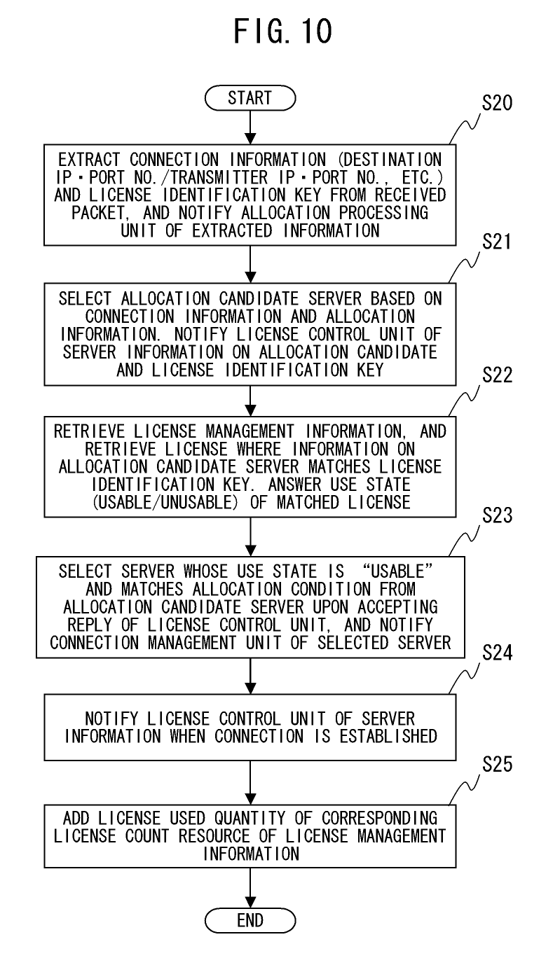

FIG. 10 is a processing flow for specifying the allocation target at the time of establishing the connection, and reflecting the specified allocation target in the license management information.

In the processing flow of FIG. 10, when access from the client 4 is a new connection establishment request, the connection management unit 13 extracts, from the received packet, the connection information (destination IP address, destination port No., transmitter IP address, transmitter port No., etc.) and the license identification key, and notifies the allocation processing unit 15 of the extracted connection information (Step S20).

The allocation processing unit 15 selects the servers 2 that match “allocation key” based on the received connection information and allocation information 77 as the allocation candidate servers, and notifies the license control unit 11 of the server identification information on the selected allocation candidate server and the license identification key (Step S21).

The license control unit 11 retrieves the license management information 73, and retrieves the license that matches the license identification key from the license information on the allocation candidate servers. The license control unit 11 answers the license state (enable/disable) of the matched license (Step S22).

Upon accepting a reply from the license control unit 11, the allocation processing unit 15 selects one server that is usable and matches the allocation condition from the allocation candidate servers, and notifies the connection management unit 13 of the selected server 2 (Step S23).

When the connection between the server 2 selected as the allocation target and the client 4 is established, the connection management unit 13 notifies the license control unit 11 of the server identification information on the server 2 establishing the connection, and information on the license identification key, the resource to be counted, etc. (Step S24).

Upon accepting the notification of the connection management unit 13, the license control unit 11 adds the used quantity of the appropriate license of the license management information 73 based on the license count method (Step S25).

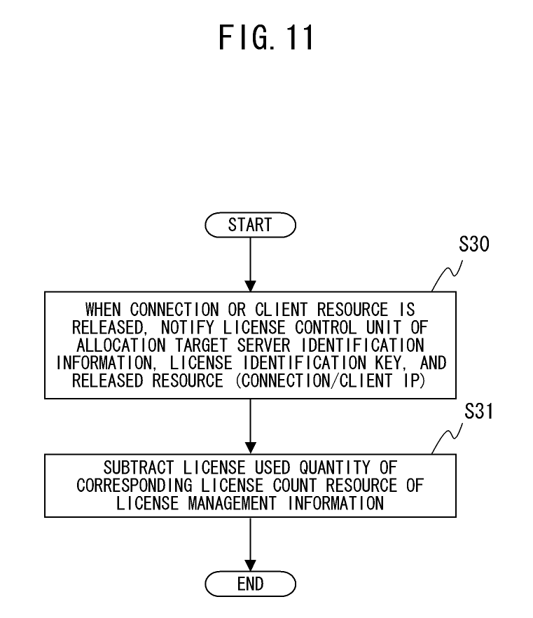

FIG. 11 is a processing flow for reflecting the connection release in the license management information.

In the processing flow of FIG. 11, when the connection or the resource of the client 4 is released, the connection management unit 13 notifies the license control unit 11 of the server identification information on the appropriate server 2, and information on the license identification key, the released resource to be counted (connection/client IP, etc.) (Step S30).

Upon accepting the notification of the connection management unit 13, the license control unit 11 subtracts the used quantity of the appropriate license of the license management information based on the license count method (Step S31).

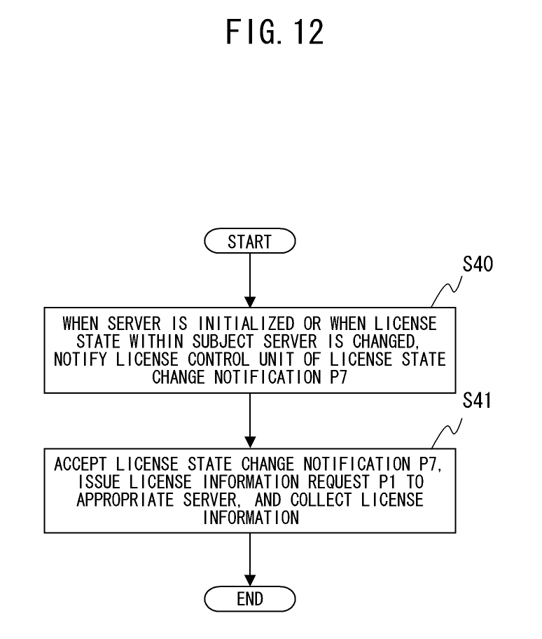

FIG. 12 is a processing flow for reflecting a change of the license information in the license management information.

In the processing flow of FIG. 12, when the server conducts initial start or when the status of the license within the subject server is changed (for example, when the service is unexecutable, when the usable license quantity is changed, etc.), the license management agent 21 notifies the license control unit 11 of a license state change notification P7 (Step S40).

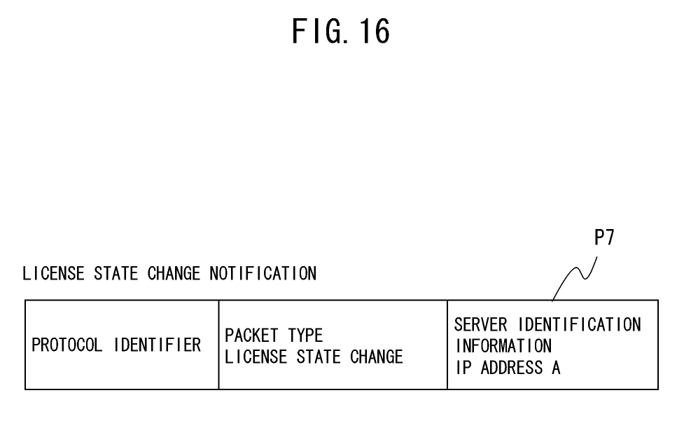

The license state change notification P7 includes the protocol identifier, the packet type (license state change) and the server identification information (IP address A, etc.) as depicted in FIG. 16.

Upon accepting the license state change notification P7, the license control unit 11 issues the license information request P1 of FIG. 13A to the appropriate server 2, and acquires the license information 71 (Step S41).

The present invention has been described above with reference to the embodiments. However, the present invention can be variously modified without departing from the spirit of the invention.

Also, the load balancer 1 can be executed as program read and executed by a computer. Program realizing the load balancer 1 can be stored in an appropriate recording medium such as a portable medium memory, a semiconductor memory, and a hard disk, which are readable by the computer, and is provided with being recorded in those recording medium, or provided by transmission or reception over various communication networks via a communication interface.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiment of the present invention have been described in detail, it should be understood that the various changes, substitutions, and alterations could be made hereto without departing from the spirit and scope of the invention.

What is claimed is:

1. A load balancer which is connected to a plurality of clients each having a license of server access, and a plurality of servers each offering a service to the clients based on license information managed by the apparatus, and distributes the access from the clients to the servers, the apparatus comprising:
a license control unit that performs a process for collecting the license information managed by the plurality of servers, respectively, and managing the use state of the licenses of each of the plurality of servers based on license management information that records the usable quantity, the used quantity, and availability/unavailability of the licenses in each of the servers and each of licenses, a process for answering availability or unavailability of an appropriate license from the license management information to an inquiry of the use state of the license in allocation candidate servers to which an access from the client are allocatable, and a process for updating the used quantity and the use state of the license management information on the license used by the server connected when the connection of the client is established;
a connection management unit that performs a process for extracting, when receiving an access request to the server from the client, identification information on the license possessed by the requesting client from a packet of the access request, and issuing an allocation target determination request based on the identification information on the extracted license, and a process for accepting a reply to the determination request, managing a connection between the server to be allocated which is specified by the reply and the client, and notifying, when the connection is established, the license control unit of the identification information on the server to be allocated and the identification information on the license used for the connection; and
an allocation processing unit that performs a process for holding allocation information defining a correspondence relationship between each of the plurality of servers and the allocatable licenses in advance, selecting the servers being the allocation candidates from the allocation information based on the identification information on the license of the determination request when accepting the determination request, and inquiring of the license control unit about the use state of the license by the selected server, and a process for specifying the server to be allocated from the allocation candidate servers, and notifying the connection management unit of the specified server based on the availability or unavailability of the license included in the reply to the inquiry.

2. The load balancer according to claim 1,
wherein the connection management unit notifies, when the connection between the client and the server is released, the license control unit of the identification information on the server whose connection is released and the identification information on the license used for the connection, and
wherein the license control unit updates the used quantity and use state of the license management information on the license used by the server whose connection is released.

3. The load balancer according to claim 1,
wherein when the count method of the license used quantity is set to the license information collected from the client by using the client resource, and the client resource is set to the client identification information extracted from the packet of the client, the license control unit stores the client resource in the license management information, and updates the used quantity of the license used by the server whose connection is established or released in units of the client resource.

4. The load balancer according to claim 1,
wherein the license control unit collects the license information from each of the plurality of servers, and updates the license management information every given period or opportunity.

5. The load balancer according to claim 1,
wherein when the license control unit accepts the notification of the license information change from any one of the plurality of servers, the license control unit acquires the license information from the notifying server, and updates the license management information.

6. A load balancing method executed by a load balancer which is connected to a plurality of clients each having a license enabling server access, and a plurality of servers each offering a service to the clients based on license information managed by the apparatus, and distributes the access from the clients to the servers, the method comprising:
a process for collecting the license information managed by the plurality of servers, respectively, holding license management information that records the usable quantity, the used quantity, and the availability/unavailability of the license in each of the servers and each of the licenses in a memory unit in advance, and managing the use state of the license of each of the servers based on the license management information;
a process for extracting, when the client makes an access request to the server, identification information on the license processed by the requesting client from a packet of the access request, and issuing an allocation target determination request based on the extracted identification information on the license;
a process for holding allocation information that defines a correspondence relationship between each of the plurality of servers and the allocatable licenses in advance, selecting, when accepting the determination request, the servers that are allocation candidates from the allocation information based on the identification information on the license of the determination request, and inquiring of the license control unit about the use state of the license by the selected server;
a process for answering the availability or unavailability of an appropriate license from the license management information to the inquiry of the use state of the license of the selected server;
a process for specifying the server to be allocated from the allocation candidate servers based on the availability or unavailability of the license included in the answer to the inquiry;
a process for managing a connection of the server to be allocated and the client, and notifying, when the connection is established, the identification information on the server to be allocated and the identification information on the license used for the connection; and
a process for updating, when the connection is established, the used quantity and the use state of the license management information on the license used by the connected server.

7. A recording medium with load balancing program for allowing accesses from a plurality of clients each having a license enabling a server access to be distributed to a plurality of servers each offering a service to the clients based on license information managed by the apparatus, the program allowing a computer connected to the clients and the servers to function as:
a license control unit that performs a process for collecting the license information managed by the plurality of servers, respectively, and managing the use state of the license of each of the plurality of servers based on license management information that records the usable quantity, the used quantity, and the availability/unavailability of the license in each of the servers and each of the licenses, a process for answering the availability or unavailability of an appropriate license from the license management information to an inquiry of the use state of the license in allocation candidate servers to which an access from the client is allocatable, and a process for updating the used quantity and the use state of the license management information on the license used by the server which is connected when the connection of the client is established;
a connection management unit that performs a process for extracting, when receiving an access request to the server from the client, identification information on the license possessed by the requesting client from the packet of the access request, and issuing an allocation target determination request based on the identification information on the extracted license, and a process for accepting a reply to the determination request, managing a connection between the server to be allocated which is specified by the reply and the client, and notifying, when the connection is established, the license control unit of the identification information on the server to be allocated and the identification information on the license used for the connection; and
an allocation processing unit that performs a process for holding allocation information defining a correspondence relationship between each of the plurality of servers and the allocatable licenses, selecting the servers that are allocation candidates from the allocation information based on the identification information on the license of the determination request when accepting the determination request, and inquiring of the license control unit about the use state of the license by the selected server, and a process for specifying the server to be allocated from the allocation candidate servers, and notifying the connection management unit of the specified server based on the availability or unavailability of the license included in the reply to the inquiry.
